(19) United States
(12) Patent Application Publication
(10) Pub. No.: US 2026/0296820 A1
(43) Pub. Date: Oct. 1, 2026

(54) ROLLED MATERIAL, METHOD, AND DEVICE

(71) Applicant: Robert Bosch GmbH, Stuttgart (DE)

(72) Inventors: Daniel Hasenkopf, Breitbrunn (DE); David Thomann, Bamberg (DE)

(21) Appl. No.: 19/477,624

(22) PCT Filed: Apr. 8, 2024
(86) PCT No.: PCT/EP2024/059417

§ 371 Date: Oct. 22, 2025

(30) Foreign Application Priority Data
Apr. 28, 2023 (DE) 10 2023 203 945.1

(51) Int. Cl. B65H 16/00; H01M 4/88

(52) U.S. Cl. CPC B65H 16/00; B65H 2301/542; B65H 2301/544; B65H 2511/416; B65H 2511/514; B65H 2511/52; B65H 2701/1842; H01M 4/8807; H01M 4/881

(57) ABSTRACT

Rolled material (10), in particular rolled material (10) for a gas diffusion layer or a membrane coated with a catalyst, for a continuous processing procedure for producing an electrochemical energy converter, comprising a roll start (12) and a roll end (14); a start information code (16) for providing information (18) regarding the rolled material (10) for the processing procedure at the roll start (12); an end code (20) for terminating the processing procedure at the roll end (14); at least one fault location (22) in and/or on the rolled material (10), wherein a start-of-fault code (24) is provided at the start of the at least one fault location (22), and an end-of-fault code (26) is provided at the end of the at least one fault location (22).

### BACKGROUND

The invention relates to a rolled material, a method, and a device.

Fault markings in the form of a line shortly before the fault location with respect to a continuous procedure for detecting fault locations on a rolled material are known from prior art. These lines are then to be detected by a light barrier as the rolled material is fed to a continuous procedure, i.e., unrolled, in order to be able to output an error message, for example, or to be able to more easily track a faulty element.

However, when detecting a line on a rolled material using a light barrier, it cannot be ensured that all marked fault locations have been detected. It is also not possible to determine which fault locations have been detected and which have not. Ultimately, this results in a worse finished product or a high number of rejects.

### SUMMARY

The invention relates to a rolled material for a continuous processing procedure for producing an electrochemical energy converter according to the disclosure, by means of a method according to the disclosure, as well as by means of a device according to the disclosure. Further features and details of the invention arise from the dependent claims, the description, and the drawings. In this context, features and details described in connection with the rolled material according to the invention clearly also apply in connection with the method according to the invention and/or the device according to the invention, and respectively vice versa so that, with respect to the disclosure, mutual reference to the individual aspects of the invention is or can always be made.

A first aspect of the invention relates to a rolled material, in particular a rolled material for a gas diffusion layer or a membrane coated with a catalyst, for a continuous processing procedure for producing an electrochemical energy converter comprising a roll start and a roll end. The rolled material has a start information code to provide information about the rolled material for the processing procedure at the roll start and an end code to terminate the processing procedure at the roll end. In addition, at least one fault location is provided in and/or on the rolled material, wherein a start-of-fault code is provided at the start of the at least one fault location, and an end-of-fault code is provided at the end of the at least one fault location.

A start information code, an end code, a start-of-fault code, or an end-of-fault code is understood to mean a marking in terms of a one-dimensional code or a two-dimensional code, such as a data matrix code or a QR code. These may comprise different information.

These two-dimensional codes can be printed or lasered onto the rolled material and thus cannot be removed from the rolled material or blurred in the winding process. This increases the likelihood of being detected and read by a reading unit.

It is conceivable that the start-of-fault code and the end-of-fault code are configured as a continuous fault code, wherein this is located along the fault location parallel to an edge of the rolled material.

Such rolled material or the arrangement of the different codes at the respectively provided positions allow redundant fault detection of the fault locations.

In the context of the invention, it may be advantageous for the start information code to have information on the number of fault locations, whereby additional information is stored about the length of the rolled material and/or the length of the fault locations and/or the position of the fault locations.

Due to this information, and in particular the information about the number of fault locations, error messages can be transmitted during the detection of the fault locations. This error message can cause the process to be interrupted or discontinued. At the same time, it is conceivable that the process will continue, but the area of the rolled material in which the error message occurs will be stored in the system in order to be able to mark the resulting products as rejects.

In the context of the invention, it is conceivable that the start-of-fault code comprises information about the assigned number of the respective fault location, and in particular the length of the fault location.

In the present case, the assigned number means that the fault locations are consecutively numbered so that a comparison with the stored number of fault locations is possible.

This allows one to directly detect when a fault location or start-or end-of-fault code has or has not been read.

It may be conceivable in the context of the invention that at least one intermediate fault code is located between the start-of-fault code and the end-of-fault code along the at least one fault location, wherein the intermediate fault code contains at least the information that the at least one fault location is still present.

This is particularly advantageous if the fault location goes over a long distance. This may ensure that no false alarm is triggered if no end-of-fault code or the like is detected over a longer distance or period of time.

It may be conceivable in the context of the invention that the start information code, the end code, the start-of-fault code, and the end-of-fault code are located along a straight line, in particular a straight line, which runs parallel to a side edge of the rolled material.

This simplifies the positioning of the respective code by means of a printer or a laser as well as the reading of the respective code by means of a reading unit. This may ensure that the codes are detected and read by the reading unit.

A second aspect of the invention is a method for detecting fault locations on a rolled material according to one of the preceding claims, wherein the rolled material is continuously moved or unrolled in a processing procedure, comprising the steps of:
S1 reading the start information code at the roll start of the rolled material by means of a reading unit,
S2 processing the information from the read start information code by means of a processing unit,
S3 reading a start-of-fault code at the start of the at least one fault location by means of the reading unit,
S4 processing the information from the read start-of-fault code by means of the processing unit,
S5 comparing the information from the read start-of-fault code with the information from the read start information code and/or a previously read start-of-fault code by means of a comparison unit,
S6 analyzing the compared information by means of an analysis unit:
   if the information from the read start-of-fault code does not match the information from the read start information code and/or the previously read start-of-fault code, an error message is output and the processing procedure is interrupted and/or discontinued or the fault location is marked, and in particular stored in the system,
   if the information from the read start-of-fault code matches the information from the read start information code and/or the previously read start-of-fault code, the processing procedure is further performed as follows:
S7 reading an end-of-fault code at the end of the at least one fault location by means of the reading unit,
S8 comparing the information from the end-of-fault code with the information from the read start information code and/or the previously read start-of-fault code using the comparison unit, wherein an error message is output when another start-of-fault code is immediately read after reading a start-of-fault code,
S9 repeating the previous steps S3 to S8
S10 reading an end code at the roll end of the rolled material by means of the reading unit,
S11 ending the processing procedure.

The processing procedure, to which the rolled good is fed, a continuous processing procedure, such as applying the catalyst layer to a membrane coated with a catalyst. Accordingly, the rolled material is continuously unrolled from a winding and also continuously fed to fault location detection method.

Upon analysis of the compared information in S6, the error message is output if the information does not match, or if another start-of-fault code is immediately read after reading a start-of-fault code without reading an end-of-fault code.

This method is a redundant control method for fault location detection, since control or comparison of the information takes place at several locations. On the one hand, the method can be used to determine which fault location is currently present and whether an end-of-fault code has been skipped or not. The range of the rolled material or the product produced in the processing procedure, which has a defect and thus is rejected, can thus be better specified.

It is further conceivable that the number of each read start-of-fault code is compared with the number of the previously read start-of-fault code in the comparison unit, wherein an error message is output if the numbers are not consecutive.

This ensures that all fault locations are detected. If a start-of-fault code with the number n is followed by a start-of-fault code with the number n+1, an error message will not be output. However, if the start-of-fault code with the number n is followed by a start-of-fault code with the number n+2 or greater, an error message is output because the error with the number n+1 was then not read.

This may then be forwarded, for example, to a control unit of the processing procedure to remove there the area of the rolled material from the ongoing process between the start-of-fault code number n and the start-of-fault code number n+2. For this purpose, both the method of fault location detection and the processing procedure may be interrupted and/or discontinued.

Furthermore, it is conceivable that, in an intermediate step S3.1, the at least one intermediate fault code, which is located between the start-of-fault code and the end-of-fault code along the at least one fault location, is read by means of the reading unit and that, in an intermediate step S4.1, the at least one intermediate fault code is processed by means of the processing unit.

The at least one intermediate fault code is particularly advantageous in the case of long and pronounced fault locations, in which the suspicion of a missed end-of-fault code or the like can occur. The at least one intermediate fault code may notify the processing unit that the fault location still exists with the start-of-fault code just read.

Advantages which have been described in detail with respect to the rolled material according to the first aspect of the invention apply equally to the fault location detection method on a rolled material according to the second aspect of the invention.

A third aspect of the invention is a device for detecting fault locations on a rolled material for a continuous processing procedure for producing an electrochemical energy converter, wherein the device is configured to perform the method just described. The device comprises a feeder unit for feeding rolled material, a reading unit for reading the start information code, the start-of-fault code and the end-of-fault code, a processing unit for processing the read information from the start information code, the start-of-fault code and the end-of-fault code, a comparison unit for comparing the processed information from the start information code and the start-of-fault code and/or the end-of-fault code to each other and an analysis unit for analyzing the compared information.

This device allows the described fault location detection method on the described rolled material to be carried out in a simple manner.

It is also conceivable that a control unit is provided, wherein the reading unit, the processing unit, the comparison unit and the analysis unit are provided in the control unit.

This reduces the size of the device according to the invention. Advantages that have been described in detail with respect to the rolled material according to the first aspect of the invention or the method for detection of fault locations on a rolled material according to the second aspect of the invention apply equally to the device for detection of fault locations on a rolled material according to the third aspect of the invention.

### BRIEF DESCRIPTION OF THE DRAWINGS

Further advantages, features, and details of the invention follow from the description hereinafter, in which multiple exemplary embodiments of the invention are described in detail with reference to the drawings. In this context, the features mentioned in the claims and in the description can each be essential to the invention individually or in any combination. The invention is illustrated in the following drawings:

FIG. 1 a schematic representation of a rolled material according to the invention,

FIG. 2 a schematic illustration of a method according to the invention,

FIG. 3 a schematic illustration of a device according to the invention.

### DETAILED DESCRIPTION

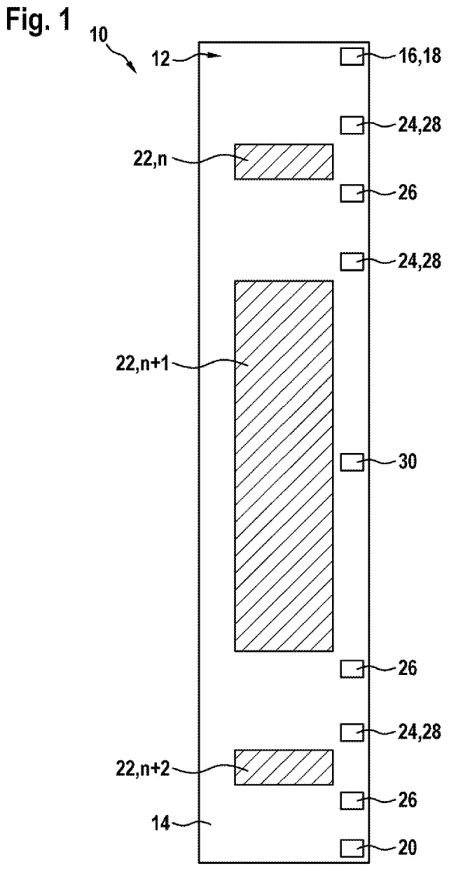

In FIG. 1, a rolled material 10, in particular a rolled material 10 for a gas diffusion layer or a membrane coated with a catalyst, for a continuous processing procedure for producing an electrochemical energy converter is shown. The rolled material 10 has a roll start 12 and a roll end 14, wherein a start information code 16 is provided for providing information 18 about the rolled material 10 for the processing procedure at the roll start 12 and an end code 20 for terminating the processing procedure at the roll end 14. Furthermore, the rolled material 10 comprises at least one fault location 22 n, n+1, n+2 in and/or on the rolled material 10, wherein a start-of-fault code 24 is provided at the start of the at least one fault location 22, and an end-of-fault code 26 is provided at the end of the at least one fault location 22.

Information 18 about the number of fault locations 22 in and/or on the rolled material 10 and about the length of the rolled material 10 are stored in the start information code 16. In addition, information 18 about the length of the fault locations 22 and/or the position of the fault locations 22 may also be stored.

The respective start-of-fault code 24 has information 28 relating to the assigned number n, n+1, n+2 of the respective fault location 22.

Since fault location 22 n+1 is longer than fault locations 22 n and n+2, at least one intermediate fault code 30 is located between start-of-fault code 24 and end-of-fault code 26 along at least one fault location 22 n+1, wherein intermediate fault code 30 at least contains the information that the at least one fault location 22 is still present and no end-of-fault code 26 was to be expected so that no error is triggered.

Furthermore, the start information code 16, the end code 20, the start-of-fault code 24, and the end-of-fault code 26 are located along a straight line, in particular a straight line, which is parallel to a side edge of the rolled material 10.

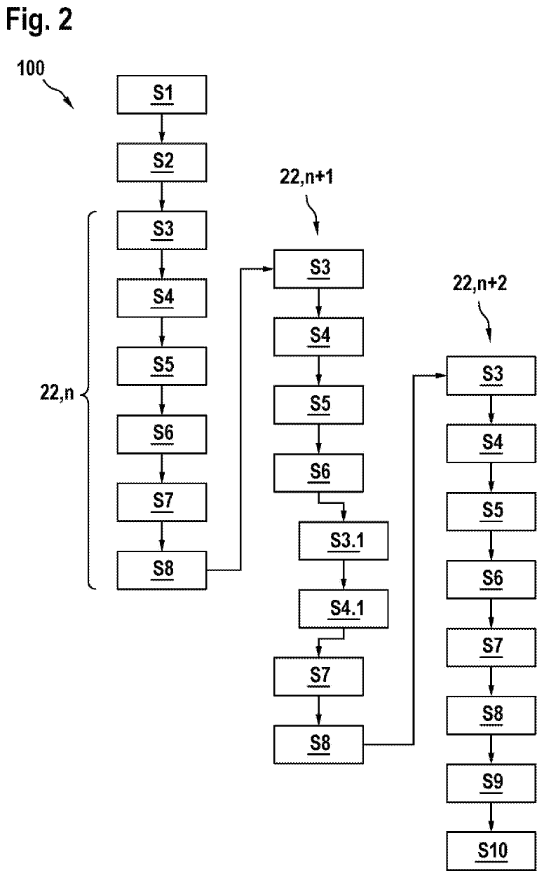

In FIG. 2, the method 100 for fault location detection on a rolled material 10 according to FIG. 1 is shown. The rolled material 10 is continuously moved in a processing procedure. The method 100 has the following steps:
S1 reading the start information code 16 at the roll start 12 of the rolled material 10 by means of a reading unit 44,
S2 processing the information 18 from the read start information code 16 by means of a processing unit 46,
S3 reading a start-of-fault code 24 at the start of the at least one fault location 22 using the reading unit 44,
S4 processing the information 28 from the read start-of-fault code 24 by the processing unit 46,
S5 comparing the information 28 from the read start-of-fault code 24 with the information 18 from the read start information code 16 and/or a previously read start-of-fault code 24 by means of a comparison unit 48,
S6 analyzing the compared information 18, 28 by means of an analysis unit 50:
   if the information 28 from the read start-of-fault code 24 does not match the information 18 from the read start information code 16 and/or the previously read start-of-fault code 24, an error message is output and the processing procedure is interrupted and/or discontinued or the fault location is marked, and in particular stored in a system,
   if the information 28 from the read start-of-fault code 24 matches the information 18 from the read start information code 16 and/or the previously read start-of-fault code 24, the processing procedure is further performed as follows:
S7 reading an end-of-fault code 26 at the end of the at least one fault location 22 by means of the reading unit 44,
S8 comparing the information from the end-of-fault code 26 with the information 18, 28 from the read start information code 16 and/or the previously read start-of-fault code 24 by means of the comparison unit 48, wherein an error message is output when another start-of-fault code 24 is immediately read S3 after reading S3 a start-of-fault code 24,
S9 repeating the previous steps S3 to S8
S10 reading an end code 20 at the roll end 14 of the rolled material 10 by means of the reading unit 44,
S11 ending the processing procedure.

The number of the respectively read start-of-fault code 24 is compared with the number of the previously read start-of-fault code 24 in the comparison unit 48. An error message is output if the numbers are not consecutive. Thus, if the start-of-fault code of the fault location n is read, processed, analyzed, and compared, and then the start-of-fault code of the fault location n+2 is read, an error message is output.

At a long fault location 22, such as fault location 22 n+1 in FIG. 1, in an intermediate step S3.1, the at least one intermediate fault code 30, which is located between the start-of-fault code 24 and the end-of-fault code 26 along the at least one fault location 22, is read by means of the reading unit 44 and, in an intermediate step S4.1, the at least one intermediate fault code 30 is processed by means of the processing unit 46. This ensures that the processing unit 46 is informed that the fault location 22 just read is still present and that an error message is not necessary.

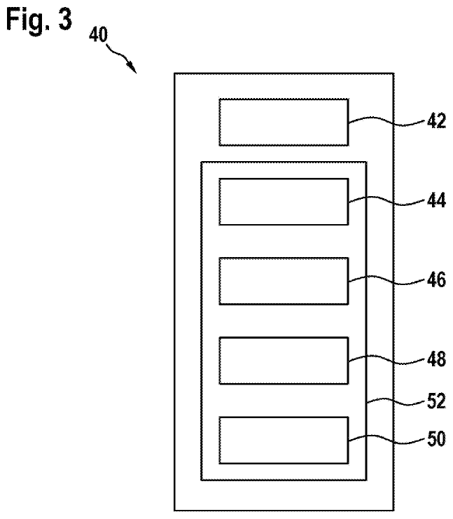

FIG. 3 shows a device 40 for detecting fault locations on a rolled material 10 for a continuous processing procedure for producing an electrochemical energy converter. The device 40 is configured to perform the method 100 according to FIG. 2. The device 40 comprises a feeder unit 42 for feeding rolled material 10, a reading unit 44 for reading the start information code 16, the start-of-fault code 24 and the end-of-fault code 26, a processing unit 46 for processing the read information 18 from the start information code 16, the start-of-fault code 24 and the end-of-fault code 26, a comparison unit 48 for comparing the processed information 18, 28 from the start information code 16 and the start-of-fault code 24 and/or the end-of-fault code 26 to each other and an analysis unit 50 for analyzing the compared information 18, 28.

A control unit 52 comprises the reading unit 44, the processing unit 46, the comparison unit 48 and the analysis unit 50.

1. A rolled material (10) for a continuous processing procedure for producing an electrochemical energy converter,
comprising: a roll start (12) and a roll end (14),
a start information code (16) for providing information (18) about the rolled material (10) for the processing procedure at the roll start (12),
an end code (20) for terminating the processing procedure at the roll end (14),
at least one fault location (22) in and/or on the rolled material (10), wherein a start-of-fault code (24) is provided at a start of the at least one fault location (22), and an end-of-fault code (26) is provided at an end of the at least one fault location (22).

2. The rolled material (10) according claim 1,
wherein
the start information code (16) comprises information (18) about a number of fault locations (22), wherein additional information (18) about a length of the rolled material (10) and/or a length of the fault locations (22) and/or a position of the fault locations (22) is stored.

3. The rolled material (10) according to claim 1,
wherein
the start-of-fault code (24) comprises information (28) about an assigned number of the respective fault location (22).

4. The rolled material (10) according to claim 1,
wherein
at least one intermediate fault code (30) is located between the start-of-fault code (24) and the end-of-fault code (26) along the at least one fault location (22), wherein the intermediate fault code (30) contains at least information that the at least one fault location (22) is still present.

5. The rolled material (10) according to claim 1,
wherein
the start information code (16), the end code (20), the start-of-fault code (24), and the end-of-fault code (26) are located along a straight line.

6. A method (100) for detecting fault locations on a rolled material (10) according to claim 1, wherein the rolled material (10) is continuously moved in a processing procedure, comprising the steps of:
(S1) reading the start information code (16) at the roll start (12) of the rolled material (10) by a reading unit,
(S2) processing the information (18) from the read start information code (16) by processing unit (46),
(S3) reading a start-of-fault code (24) at the start of the at least one fault location (22) by the reading unit (44),
(S4) processing the information (28) from the read start-of-fault code (24) by the processing unit (46),
(S5) comparing the information (28) from the read start-of-fault code (24) with the information (18) from the read start information code (16) and/or a previously read start-of-fault code (24) by a comparison unit (48),
(S6) analyzing the compared information (18, 28) by an analysis unit (50):
if the information (28) from the read start-of-fault code (24) does not match the information (18) from the read start information code (16) and/or the previously read start-of-fault code (24), an error message is output and the processing procedure is interrupted and/or discontinued or the fault location is marked,
if the information (28) from the read start-of-fault code (24) matches the information (18) from the read start information code (16) and/or the previously read start-of-fault code (24), the processing procedure is further performed as follows:
(S7) reading an end-of-fault code (26) at the end of the at least one fault location (22) by means of the reading unit,
(S8) comparing the information from the end-of-fault code (26) with the information (18, 28) from the read start information code (16) and/or the previously read start-of-fault code (24) by the comparison unit (48), wherein an error message is output when another start-of-fault code (24) is immediately read S3 after reading S3 a start-of-fault code (24),
(S9) repeating the previous steps S3 to S8,
(S10) reading an end code (20) at the roll end (14) of the rolled material (10) by the reading unit,
(S11) ending the processing procedure.

7. The method (100) according to claim 6,
wherein
a number of each read start-of-fault code (24) is compared with a number of the previously read start-of-fault code (24) in the comparison unit (48), wherein an error message is output if the numbers are not consecutive.

8. The method (100) according to claim 6,
wherein
in an intermediate step (S3.1), the at least one intermediate fault code (30) located between the start-of-fault code (24) and the end-of-fault code (26) along the at least one fault location (22) is read by the reading unit (44), and,
in an intermediate step S4.1, the at least one intermediate fault code (30) is processed by the processing unit (46).

9. A device (40) for detecting fault locations on a rolled material (10) for a continuous processing procedure for producing an electrochemical energy converter, wherein the device (40) is configured to perform the method (100) according to claim 6,
comprising a feed unit (42) for feeding a rolled material (10),
a reading unit (44) for reading the start information code (16), the start-of-fault code (24), and the end-of-fault code (26),
a processing unit (46) for processing the read information (18) of the start information code (16), the start-of-fault code (24), and the end-of-fault code (26),
a comparison unit (48) for comparing the processed information from the start information code (16) and the start-of-fault code (24) and/or the end-of-fault code (26) with one another, and
an analysis unit (50) for analyzing the compared information.

10. The device (40) according to claim 9,
wherein
a control unit (52) is provided, wherein the reading unit the processing unit (46), the comparison unit (48) and the analysis unit (50) are provided in the control unit (52).

11. The rolled material (10) according claim 1, wherein the rolled material is a rolled material (10) for a gas diffusion layer or a membrane coated with a catalyst.

12. The rolled material (10) according claim 3, wherein the start-of-fault code (24) comprises a length of the fault location (22).

13. The rolled material (10) according claim 5, wherein the straight line is parallel to a side edge of the rolled material (10).

14. The method (100) according claim 6, wherein the fault location is marked and stored in a system.
